(19) United States
(12) Patent Application Publication
(10) Pub. No.: US 2006/0001542 A1
(43) Pub. Date: Jan. 5, 2006

(54) System for monitoring mobile personal items

(76) Inventor: Heikki Waris, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/879,692

(22) Filed: Jun. 30, 2004

(51) Int. Cl. G08B 13/14

(52) U.S. Cl. 340/572.1; 340/539.13

(57) ABSTRACT

A system for monitoring mobile personal items which are equipped with a radio-frequency tag includes user equipment having a number of elements. The user equipment includes a radio frequency tag detector which is capable of detecting a radio frequency tag. The user equipment is also capable of performing an earlier and a later operation of the detector, and compares the outputs of the detector for the earlier and later operations and provides a monitor output dependent on the comparison. The monitor output indicates whether a personal item which is detected as being present on the earlier operation is present on the later operation.

### FIELD OF THE INVENTION

The present invention relates to a system for monitoring mobile personal items and in particular but not exclusively to a system for monitoring mobile personal items using a cellular telephone for use in a wireless communication cellular network.

### BACKGROUND OF THE INVENTION

Communication systems wireless communication for user equipment are known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based an appropriate communication protocol.

The operation of the base station apparatus and other apparatus required for the communication can be controlled by one or several control entities. The various control entities may be indicated.

User equipment such as mobile stations or mobile phones are one of several item types referred to as mobile essentials (ME), in other words items that people place a significant importance upon in their day-to-day lives. Other examples of mobile essentials are keys, wallets, and travel cards.

Typically these mobile essentials (ME) are carried on the person close to each other, for example within pockets of trousers and/or jackets, or within a handbag. Often these mobile essentials are taken from their usual storage place, for example when they are being used, e.g. a wallet is removed from a pocket in order to purchase an item, a travel card will be swiped or placed next to a travel card reader in order to gain access to a public transport utility.

These mobile essentials (ME) are also typically removed from the person when the person is relaxing in social situations, these mobile essentials can be forgotten as the person leaves the location.

There is therefore a problem to be solved in reminding the user that they have forgotten something close to the phone as they are about to leave or leaving the location.

Although it is known in the art that devices can be connected to a mobile phone using a Bluetooth link, such as a wireless headset and user equipment can be connected, and that the mobile phone can indicate to the user when the linked device is close by, the Bluetooth circuitry required is expensive and therefore costly to implement on mobile essential items. Also Bluetooth systems require a power source leading to relatively bulky transceiver modules, which are often aesthetically unpleasing when located on delicate items such as jewellery. Furthermore Bluetooth supports only a limited number of Bluetooth connections from the user equipment to the linked device.

It is the aim of embodiments of the present invention to address or at least mitigate the problems described above.

### SUMMARY OF THE INVENTION

There is provided according to the present invention a system for monitoring mobile personal items each equipped with a radio-frequency tag; comprising user equipment comprising: a radio-frequency tag detector, said radio-frequency tag detector capable of detecting a radio-frequency tag, wherein the user equipment is capable of performing an earlier and a later operation of the detector, and to compare the outputs of the detector for the earlier and later operations and provide an monitor output dependent on the comparison, the monitor output indicating whether a mobile personal item detected as being present on the earlier operation is present on the later operation.

The user equipment may further comprise a further detector for detecting motion of the user equipment.

The further detector may further distinguish types of motion of the user equipment.

The user equipment is preferably capable of performing at least one of the operations of the detector dependent on the output of the further detector.

The user equipment is preferably capable of performing at least one of the operations of the detector dependent on the further detector detecting that the user equipment is in a moving state.

The moving state is preferably detected when the user equipment is in motion whilst being carried by a user.

The moving state may be detected when the user equipment is in motion for more than a first predetermined period.

The user equipment is preferably capable of performing at least one of the operations of the detector if the further detector detects that the user equipment is in a stopped state.

The further detector may comprise at least one of: an accelerometer; a gyroscope; a GPS device; a receiver capable of detecting fluctuations in received signal over distance; a mercury switch.

The further detector may be an accelerometer, whereby the accelerometer comprises accelerometer means for detecting acceleration in more one orthogonal vector.

The user equipment is preferably capable of performing at least one of the operations of the detector on receiving a manual input to the user equipment.

The user equipment is preferably arranged to initiate the later operation of the detector a predetermined time period after the earlier operation of the detector.

The user equipment may be capable of registering the mobile personal items within a memory, and filtering the outputs of the detector dependent on the registered mobile personal items.

According to a second aspect of the present invention there is provided a method for monitoring mobile personal items equipped with a radio-frequency tag, by means of user equipment comprising a radio-frequency tag detector capable of detecting the presence of a radio-frequency tag, comprising the method comprising the steps of: performing an earlier operation of the detector; performing a later operation of the detector; comparing the output of the detector for the earlier and later operations; providing a monitor output dependent on the result of the comparison step; the output whether a mobile personal item indicating the presence of the mobile personal item detected as being present on the earlier operation is present on the later operation.

The user equipment preferably has a further detector for distinguishing whether the user equipment is in a moving state, the step of performing a later operation of the detector following the steps of: detecting by means of the further detector where the user equipment is not in a moving state for a first predefined period of time; and subsequently detecting by means of the further detector where the user equipment is in a moving state for a second predefined period of time.

The method may comprise a step prior to performing an earlier operation of the detector of registering mobile personal items, and wherein the output of the earlier and later operations of the detector is preferably modified dependent on the registering step.

### BRIEF DESCRIPTION OF THE DRAWINGS

For a better understanding of the present invention and how the same may be carried into effect, reference will now be made by way of example only to the accompanying drawings in which:

FIG. 1a shows a mobile phone of a typical communications network capable of carrying out an embodiment of the present invention;

FIG. 1b shows a mobile essential capable of being used in an embodiment of the present invention; and

FIG. 2 shows a flow diagram showing the method of an embodiment of the present invention.

### DETAILED DESCRIPTION OF EMBODIMENTS OF THE PRESENT INVENTION

Embodiments of the present invention will be described by way of example, with reference to the exemplifying example of a mobile station or cellular phone as a user equipment. However it will be understood that embodiments may be applied to other suitable forms of user equipment such as laptops, and personal digital assistants (PDAs).

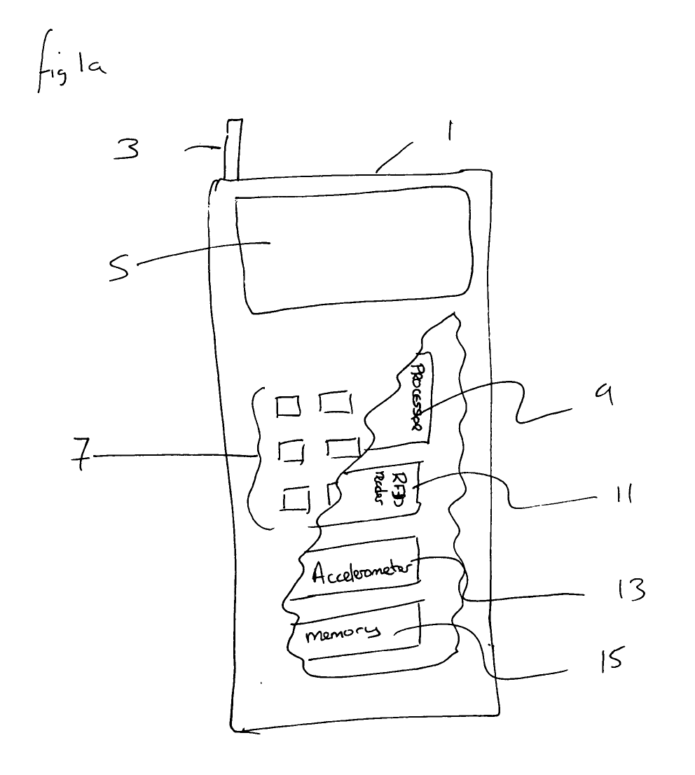

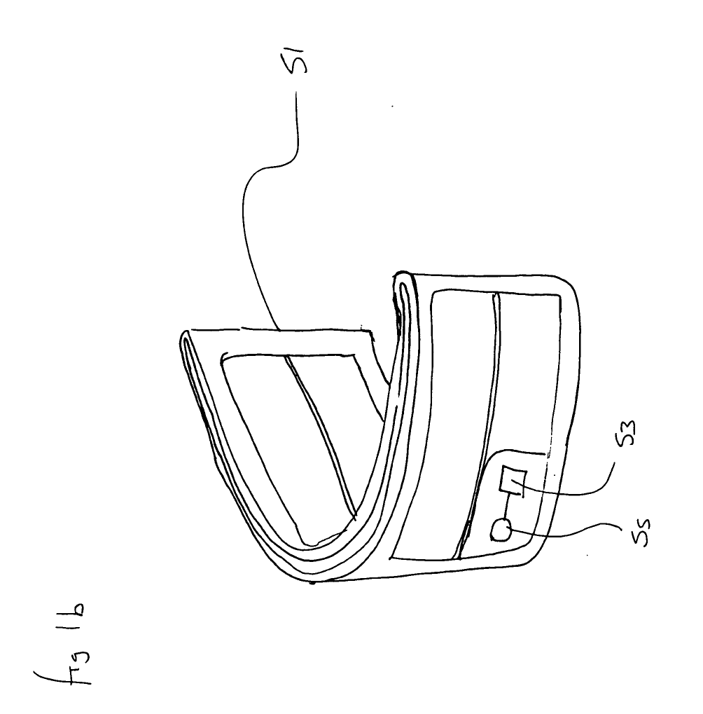

FIG. 1 shows a typical mobile station 1 which can be employed within a cellular telecommunications network. The mobile station or user equipment 1 comprises a display 5 for displaying information to the user, a key pad 7 for providing an input to the mobile station 1, and an antenna 3 connected to transceiver circuitry (not shown) for communicating to and from a cellular telecommunications base transceiver station (BTS) as known in the art.

The mobile station 1 further comprises a processor 9 for processing data in order to allow the phone to operate, and passing data to and from; the key pad 7, the RF-ID reader 11, the accelerometer 13, and the memory 15.

The mobile station 1 further comprises an RF-ID reader 11. The RF-ID reader 11 contains circuitry that can detect RF-ID tags located within the neighbourhood of the user equipment. The RF-ID reader 11 contains transceiver circuitry, enabling the device to be used with passive RF-ID tags, wherein the passive RF-ID tag stored on the item is powered from the transmitted RF-ID request signal.

In other embodiments the RF-ID reader 11 can contain circuitry allowing the detection of active RF-ID tags, where the RF-ID tag is powered from a power source within the tag.

In some embodiments of the present invention the RF-ID reader 11 can scan for RF-ID tags using an adjustable power radio frequency signal. In these embodiments of the present invention the RF-ID reader 11 can estimate the approximate distance from the mobile station 1 and the mobile essential containing the RF-ID tag.

The accelerometer 13 is capable of detecting changes in the physical state of the terminal. For example the accelerometer can detect differing accelerations, and accelerations within different directions. This acceleration information can be passed to the processor 9 for further processing.

The accelerometer 13 is designed to detect a range of motion. For example the accelerometer 13 can be designed to detect the following mobility states:—
Zero movement state (where the accelerometer 13 detects no motion ignoring indirect jitters caused by people walking nearby and other vibrations);
Stopped state (e.g. recognising a period of five seconds of zero movement state as a stopped state);
Moving state (e.g. recognising a period of two seconds of non-zero movement as a moving state).

The time periods described above are only examples of the time periods that could be used to distinguish between the mobility states.

In some embodiments of the present invention the acceleration and time thresholds for the various mobility states can be adjusted by the user, or modified by the mobile station 1. This can for example be done by the mobile station 1 to prevent false detection of stopped and moving states. For example to prevent the mobile station 1 mistakenly interpreting a short pause, such as that experienced whilst waiting to cross the road, as being a stopped state. A similar example is preventing the mobile station 1 from mistakenly indicating a moving state by a jolt caused by an accidental push impact to the mobile station 1.

In some embodiments of the present invention the accelerometer 13 can detect whether the detected motion of the mobile station 1 is the motion characteristic of being carried by a person.

Thus in further embodiments of the present invention the accelerometer can improve the movement detection accuracy by examining the directions of motion detected by the accelerometer. For example the accelerometer can be configured to ignore motion detected in only two directions, as this type of motion is unlikely to be where the mobile station 1 is being carried by a person and more likely being caused by a sliding motion on a surface.

Similarly in some embodiments of the present invention the accelerometer 13 provides improved motion state accuracy by detecting a movement average and ignoring a zero or near-zero sum of acceleration over time as this type of motion is indicative of rotational motion of the mobile station 1, i.e. zero displacement travel distance and therefore not seen as an indicator of mobility.

In further embodiments of the present invention signals from the accelerometer are passed to the processor 9 which may carry out the motion state categorisation, the motion state accuracy improvements or other functionality such as low pass filtering in order to remove the effects of motion jittering.

In some embodiments of the present invention the accelerometer 13 is a set of accelerometers detecting motion in one of three independent vectors.

In further embodiments of the present invention the accelerometer 13 is replaced with a gyroscope. In such embodiments the gyroscope monitors the change in position of the mobile station 1 and the mobility states are determined by the detected change of position of the mobile station 1.

In some embodiments of the present invention the accelerometer 13 is replaced by a means of detecting changes in the physical mobility state of the terminal, such as a mercury switch.

In some embodiments of the present invention the accelerometer 13 used to detect moving and stopped states is replaced with a GPS receiver capable of determining moving and stopped states by monitoring the estimated position of the mobile station over time.

In further embodiments of the present invention the accelerometer 13 may be replaced by the transceiver circuitry (not shown) monitoring whether the mobile station 1 is in a moving or stopped state by monitoring the received signals from the base transceiver station. For example the transceiver circuitry (not shown) could monitor an averaged received power from the base transceiver station, and after removing fluctuations/fading due to atmospheric and environmental changes provide an estimate of the moving or stopped state of the mobile station 1.

The memory 15 is used by the processor to store data for later use by the processor 9. The memory 15 may be static, dynamic random access memory, flash memory, or any rewritable memory storage unit known in the art.

With reference to FIG. 1b an example of a mobile essential (ME) operating in an embodiment of the present invention is shown.

The mobile essential (ME) in this example is a wallet 51. The wallet comprises a RF-ID tag 53. The wallet may in some embodiments further include a simple flat loop antenna 55 to provide better reception. The flat loop antenna 55 is connected to the RF-ID tag 53.

RF-ID tags may be incorporated into other types of mobile essentials, for example; keys, purses, ID badges, driving licences, jewellery, and/or travel cards. The RF-ID tags can be passive or active RF-ID tags.

As described earlier Passive RF-ID tags contain no integral power supply and require the RF-ID reader to broadcast a radio frequency signal to power the RF-ID tag to broadcast its RF-ID tag value. An active RF-ID tag contains an integral power source which enables the RF-ID tag to broadcast its RF-ID value independently of a radio frequency request signal.

Each RF-ID tag value on the mobile essential is unique, in other words each RF-ID tag identifies a separate individual mobile essential.

The RF-ID tag value attached to the mobile essential is a static value. In other words the value is the same for the life of the tag.

In other embodiments the RF-ID tag value has a pseudo static value, i.e. although the value does change, the value does not change over a period of time long enough to prevent the reader from identifying the mobile essential carrying the tag. A suitable time period is at least several hours.

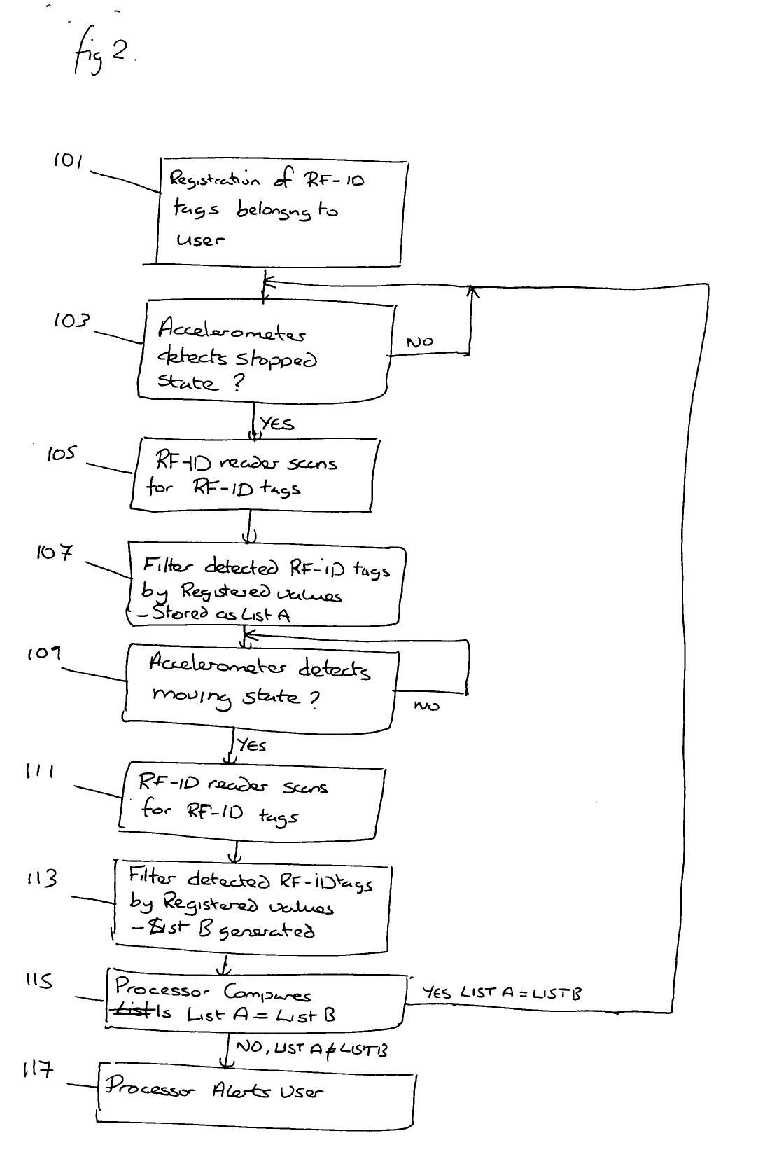

With reference to FIG. 2 the method used by an embodiment of the present invention is described.

In the first step shown in FIG. 2, step 101, the user registers their mobile essential RF-ID tagged items in their mobile station 1. This step performs a scan for RF-ID tags with the mobile station 1 RF-ID reader 11. The detected RF-ID tags, in some embodiments of the present invention, are reviewed by the user. The user is therefore capable of adding additional tag values (or mobile essential items) or removing detected tag values (such as those not recognised as being owned by the user).

Thus in some embodiments of the present invention the user of the mobile station 1 can select which of the scanned RF-ID values they wish to register. For example, the user may wish to only store the values relating to specific mobile essentials such as the wallet and jewellery. Only these selected values are then stored within the memory 15.

In further embodiments of the present invention the user can associate the RF-ID tag value with a specific mobile essential in the mobile station memory 9 enabling the mobile station to display a representation of the mobile essential scanned by the RF-ID reader 11 rather than the RF-ID tag value. This display can be graphical, textual, or a combination of the two.

In the next step, step 103, the mobile station 1 accelerometer 13 detects whether the user equipment 1 has entered a ‘stopped’ state of operation.

If the accelerometer 13 has detected a ‘stopped’ state the mobile station is assumed to be stationary and the method proceeds to step 105. If the accelerometer 13 has not detected a ‘stopped’ state the method loops back to step 103, i.e. the accelerometer 13 continues to monitor whether the mobile station 1 has entered a stopped state.

Step 105 occurs when the mobile station 1 RF-ID reader 11 performs a scan for RF-ID tags in the area surrounding the mobile station 1. The mobile essentials surrounding the user equipment 1 containing RF-ID tags are detected and the values of the scanned RF-ID tags passed to the processor 9.

The following step, step 107, is when the results of the RF-ID scan are processed. The processor performs a filtering of the detected RF-ID tags against the registered RF-ID tags. Thus only RF-ID tag values detected and registered are stored as a first list of RF-ID values, List A, in the memory 15.

In some embodiments of the present invention the user of the mobile station 1 can select which of the scanned RF-ID values they wish to store within the list.

In the next step 109 the accelerometer 13 checks whether a moving state has been detected. If a moving state has been detected the method proceeds to step 111. This in other words indicates the mobile station 1 has been detected as moving after a pause in motion, where some, all or none of the mobile essentials may have been left behind. If no moving state has been detected the method loops back to step 109, i.e. the accelerometer 13 continues to monitor whether the mobile station has begun to move following a significant pause in motion.

In the step 111 the RF-ID reader 11 scans for RF-ID tags. This is a similar test to that carried out in step 105.

In the following step 113, the detected tags are processed. The RF-ID tag values are filtered by the registered tag values and the filtered values are stored a list of RF-ID tag values. This is a similar step to that carried out in steps 107. The processor 9 generates a second list, List B, which can in some embodiments of the present invention be stored within the memory 15.

In the following step 115 the processor 9 compares List B with List A. If the first list, List A, is equal to the second list, List B, then all of the mobile essentials are determined to be close to the mobile station 1 and the method returns to detecting whether or not there is a stopped phase. In this example no items have been left.

If the first list, List A is not equal to the second, List B, then the method proceeds to step 117. In step 117 the processor alerts the user that a mobile essential identified by the difference in RF-ID value is not close to the mobile station 1. In other words the identified item has either been left or been taken whilst the user was stationary.

In the embodiment described above the user can therefore prevent any mobile essential from being mislaid in that the mobile station 1 will inform the user that the mobile essential is not within the scanning range of the RF-ID reader 11 as the mobile station 1 moves away from a stopped state

The mobile station processor 9 can then display the ‘missing’ mobile essential identified by its RF-ID value. This display can be an auditory, visual, or vibration alert.

In further embodiments of the present invention the processor 9 can assign a priority to each of the RF-ID tag values. The higher the priority associated with the RF-ID tag value, the longer (in time and/or distance) the mobile station 1 will attempt to read the tag associated with the RF-ID value.

Furthermore the higher the priority associated with a RF-ID tag value the more likely the mobile station 1 is to raise the alert for the missing item after the moving state is detected.

In some embodiments of the present invention the initial scan and storage steps 105 and 107 are carried out prior to the detection of a stopped state. Thus the mobile station 1 performs a scan of the RF-ID tags in mobile essentials to produce the first list, List A, and the mobile station 1 performs the second scan of the RF-ID tags in mobile essentials just as the mobile station 1 starts moving. In such embodiments the mobile station 1 has a static list A independent of every time the mobile station 1 is detected as being in a stopped state. In other embodiments of the present invention the first list, List A, can be generated during the initial registration step 101, with the steps 105 and 107 not being carried out.

In both of the above embodiments a smaller number of scans are required over a time period as there is no scanning following a pause in motion. This smaller number of scans can therefore prolong device operational battery life.

In further embodiments of the present invention the mobile station can be configured to perform a scan of the RF-ID tags in the mobile essentials without a detection of a moving state. In such an a user can perform a manual check of the RF-ID tags in mobile essentials, for example just when they are due to leave the house in the morning. In such an example the user is therefore able to check to see if they have all of their mobile essentials prior to leaving in the morning.

In other embodiments, if the mobile station is provided with the indicator that the user is at the user's home the mobile station 1 is configured to detect all nearby tags and only alert the user when a movement away from the home starts. The location information may be gathered from the GPS location estimate in embodiments employing a GPS locator. The location information may in some embodiments be provided by manually selecting on the mobile station 1 that the user is at home.

In other embodiments the mobile station can the mobile station 1 performs regular RF-ID scans, the scans separated by a specific time period. In such embodiments the mobile station 1 can detect whether the mobile essentials with RF-ID tags are still located close to the user and have not been stolen. For example this is useful for situations where theft of the mobile essentials is possible without the user immediately realising it for example in a restaurant, or in the street with pickpockets operating.

In further embodiments of the present invention the mobile station 1 performs a scan of the RF-ID tags at various power levels and therefore is capable of determining whether the mobile essentials during the second scan are at a different distance from the mobile station 1 than they were during the first RF-ID scan. In such embodiments of the present invention a significant distance difference can be used to indicate that the mobile station is moving away from the RF-ID tag in the mobile essential—and therefore the mobile essential has highly likely been left behind but is still near by.

In further embodiments of the present invention the mobile station 1 performs a series of scans in order to prevent any false positive indications of missing mobile essentials caused by momentary blocking of the signal between the reader and the tag. In other embodiments of the present invention the processor 9 performs subsequent registering scans at exponentially increasing intervals, adding any newly detected tags to the first list.

In further embodiments of the present invention the user is allowed to edit the stored list to remove mobile essentials from the list when not needed.

In some embodiments of the present invention the alert provided by the processor 9 is displayed on the display 5 of the mobile station 1. The alert display can be accompanied by a screen display of the missing items name, or graphical representation of the missing item.

In embodiments of the present invention where the mobile station 1 is equipped with location estimation or travelled distance estimation the lists or list values of mobile essentials may contain an associated location indicator or distance travelled indicator. Thus for example if the user is alerted that one of the mobile essentials is not close to the mobile station 1, the most recent list containing the RF-ID tag value associated with the missing item may provide an estimate when and where the last time the mobile station 1 was close to the item.

In other embodiments of the invention the monitoring device could be a dedicated monitoring device. An example of which could be a battery-powered device attachable to a key chain equipped with a RF-ID reader and a keypad. Other embodiments could feature a remote configuration interface, thus removing the need for a display on the device itself.

1. A system for monitoring mobile personal items each equipped with a radio-frequency tag; comprising
user equipment comprising: a radio-frequency tag detector, said radio-frequency tag detector capable of detecting a radio-frequency tag,
wherein the user equipment is capable of performing an earlier and a later operation of the detector, and to compare the outputs of the detector for the earlier and later operations and provide an monitor output dependent on the comparison, the monitor output indicating whether a mobile personal item detected as being present on the earlier operation is present on the later operation.

2. A system as claimed in claim 1, wherein the user equipment further comprises a further detector for detecting motion of the user equipment.

3. A system as claimed in claim 2, wherein the further detector further distinguishes types of motion of the user equipment.

4. A system as claimed in claims 3, wherein said user equipment is capable of performing at least one of the operations of the detector dependent on the output of the further detector.

5. A system as claimed in claim 4, wherein the user equipment is capable of performing at least one of the operations of the detector dependent on the further detector detecting that the user equipment is in a moving state.

6. A system as claimed in claim 5, wherein the moving state is detected when the user equipment is in motion whilst being carried by a user.

7. A system as claimed in claim 5, wherein the moving state is detected when the user equipment is in motion for more than a first predetermined period.

8. A system as claimed in claim 4, wherein the user equipment is capable of performing at least one of the operations of the detector if the further detector detects that the user equipment is in a stopped state.

9. A system as claimed in claim 2, wherein the further detector comprises at least one of:
an accelerometer;
a gyroscope;
a GPS device;
a receiver capable of detecting fluctuations in received signal over distance;
a mercury switch.

10. A system as claimed in claim 2, wherein the further detector is an accelerometer, whereby the accelerometer comprises accelerometer means for detecting acceleration in more one orthogonal vector.

11. A system as claimed in claim 1, wherein the user equipment is capable of performing at least one of the operations of the detector on receiving a manual input to the user equipment.

12. A system as claimed in claim 1, wherein the user equipment is arranged to initiate the later operation of the detector a predetermined time period after the earlier operation of the detector.

13. A system as claimed in claim 1, wherein the user equipment is capable of registering the mobile personal items within a memory, and filtering the outputs of the detector dependent on the registered mobile personal items.

14. A method for monitoring mobile personal items equipped with a radio-frequency tag, by means of user equipment comprising a radio-frequency tag detector capable of detecting the presence of a radio-frequency tag, comprising the method comprising the steps of:
performing an earlier operation of the detector;
performing a later operation of the detector;
comparing the output of the detector for the earlier and later operations;
providing a monitor output dependent on the result of the comparison step;
the output whether a mobile personal item indicating the presence of the mobile personal item detected as being present on the earlier operation is present on the later operation.

15. A method as claimed in claim 13, wherein the user equipment has a further detector for distinguishing whether the user equipment is in a moving state, the step of performing a later operation of the detector following the steps of:
detecting by means of the further detector where the user equipment is not in a moving state for a first predefined period of time; and subsequently
detecting by means of the further detector where the user equipment is in a moving state for a second predefined period of time.

16. A method as claimed in claim 13, comprising a step prior to performing an earlier operation of the detector of registering mobile personal items, and wherein the output of the earlier and later operations of the detector is modified dependent on the registering step.
